(19) United States
(12) Patent Application Publication
(10) Pub. No.: US 2025/0110817 A1
(43) Pub. Date: Apr. 3, 2025

(54) PROACTIVELY DETECTING AND PREVENTING DATA API CONNECTION FAILURE

(71) Applicant: MoneyKit, Inc., New York, NY (US)

(72) Inventors: Michael George DEL MONTE, Bradenton, FL (US); Austin James VALLESKEY, New York, NY (US); Kristopher David STIPECH, Nashville, TN (US)

(21) Appl. No.: 18/905,811

(22) Filed: Oct. 3, 2024

Related U.S. Application Data
(60) Provisional application No. 63/650,298, filed on May 21, 2024.
(60) Provisional application No. 63/542,211, filed on Oct. 3, 2023.

(51) Int. Cl. G06F 9/54

(52) U.S. Cl. CPC G06F 9/547

(57) ABSTRACT

A data application programming interface (API) platform can help connect to a data API of a financial entity. The present disclosure is related to determining that a connection to the data API via a first data API platform is likely to be unsuccessful (e.g., fail, not support, low performance, etc.) and providing a connection via a second data API platform.

### CROSS REFERENCE TO RELATED APPLICATIONS

This application claims the priority benefit of U.S. provisional patent application Nos. 63/650,298 (filed May 21, 2024) and 63/542,211 (filed Oct. 3, 2023), each of which is hereby incorporated herein by reference in its entirety.

### BACKGROUND

People often have personal information, such as information related to their personal finances, associated with (e.g., spread across) multiple different entities. For example, personal information may be associated with, and maintained by, banks, credit unions, savings/loan associations, investment companies, brokerage firms, insurance companies, payroll services, cryptocurrency companies, and the like. In some instances, people may access their personal information directly from one of these entities, such as by logging onto a website or mobile application provided by the entity to view and/or interact with the information.

In addition, with proper authentication and identify verification, people sometimes use a third-party application (e.g., fintech, web, or mobile app) to pull their information from one of these entities to use tools provided by the third-party application (e.g., tools that might not otherwise be available by the entity's website or mobile application). In some cases, a data application programming interface (API) may be provided by the entity, and used by the third-party application, to pull the information from the institution. Sometimes, when using the data API, the third-party application may leverage a data API platform, which may help facilitate API access and data retrieval from multiple institutions. That is, the data API platform may maintain data API connections (e.g., sometimes continuously/persistently) with multiple entities, such that it can be easier for a user to access their information (e.g., via third-party applications) using the already established connections, instead of needing to establish a new connection with the data API in each instance.

### BRIEF DESCRIPTION OF THE DRAWINGS

The present systems and methods for proactively detecting and preventing data API connection failure are described in detail below with reference to the attached drawing figures.

FIG. 1 depicts an example system of networked component, in accordance with examples of this disclosure.

FIG. 2 depicts an example of a method for detecting a potential data API connection failure and providing a different connection, based on examples of this disclosure.

FIG. 3 depicts a block diagram of an example computing device, based on examples of this disclosure.

### DETAILED DESCRIPTION

As described above, a data application programming interface (API) platform can help connect to a data API (e.g., of a financial entity). The present disclosure is related to detecting a failure (or anticipating a potential failure) by a data API platform to connect to a financial institution and providing a connection via a different data API platform. That is, in some instances, a user might attempt to access their information (e.g., information or details associated with a financial account) by submitting a request via a computing application (e.g., on a mobile computing device), and the request can fail where the data API platform fails to connect to the financial institution (e.g., to the computing devices associated with the financial institution). Examples of the present disclosure identify such connection failures (or anticipate potential failures before they happen) and provide a connection to the financial entity by way of a different data API platform. The request to the financial institution can then be successfully executed via the alternative connection.

Conventionally, when a request to retrieve information from a financial institution via a third-party application fails or is anticipated to fail, an alternative connection is not readily available. As such, the request may simply fail, which can leave a user without access to their financial information via the third-party application. The user can try to access the information directly from the financial institution (e.g., via a different application associated with the financial institution), but the additional functionality and options associated with the third-party application are not available to the user with respect to the information associated with that particular financial institution. As such, when using the third-party application, the user may be without information and options related to balances, withdrawal options, transfer options, investing options, and the like. That is, the user can be essentially locked out from accessing financial resources without any recourse. Not only can this limit the user's current financial resources, the delay can significantly reduce future financial resources by limiting investing potential, loan options, and the like.

In contrast to conventional solutions, the present disclosure detects a connection failure (or anticipates potential failure) and provides a connection via a different data API platform. That is, when the user is interacting with their client third-party application and is inputting information associated with a request to a financial entity (e.g., bank), the present solution can detect when a connection failure might occur (or has occurred or is occurring) and can provide the option to connect to the financial entity via a different data API platform. Once the alternative data API platform is selected, the user can proceed to submit their request to retrieve information from the financial institution via the client third-party application, and the request can be successfully executed via the alternative connection. As such, the present invention, via the technical solutions described in this application, can prevent the user from being locked out from their account information (or delayed in accessing their account information). In addition, the present disclosure can increase the likelihood that the connection is reliable and fast enough and robust enough to service the user needs and requests via the application. The solutions herein can increases user accessibility to current financial resources and to tools that can be implemented to increase future financial resources.

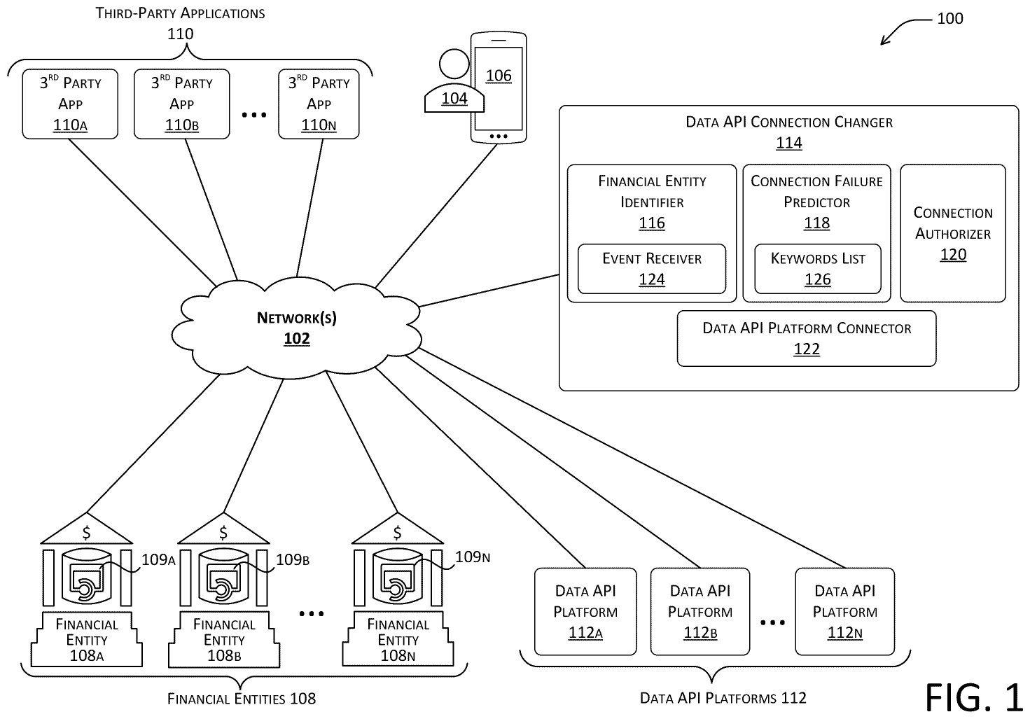

With reference to FIG. 1, FIG. 1 is an example system 100, in accordance with some examples of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

In examples, the system 100 includes a plurality of computing devices that are connected by way of one or more network(s) 102, and although sometimes described and/or depicted more abstractly, in some instances, the networked elements of the system 100 may include one or more servers or other computing devices. In some examples, the system 100 may include a user (e.g., user 104 with user computing device 106), as well as financial entities 108 (e.g., bank, lender, credit union, broker, employment benefits manager, payroll services provider, cryptocurrency services provider, credit card company, insurance company, etc.) that provide services to the user 104 and that maintain information associated with the user 104 (e.g., information generated in association with provided services).

In addition, the system 100 may include third-party applications 110 that (e.g., with permission of the user 104) access information stored by the financial entities 108 for use by the user 104. For example, in some instances, information stored by the financial entities 108 is accessible (e.g., by the user and/or third-party application) via a data API (e.g., 109a, 109b, and/or 109c). Accordingly, in some examples, the system 100 may also include data API platforms 112 (e.g., data API aggregator) that facilitate connection to the data APIs (e.g. connection by the user and/or the third-party applications).

In addition, examples of the present disclosure include a data API connection changer 114 that can detect or predict or anticipate when a first data API platform might not provide a successful connection to the financial entity (e.g., to the data API of the financial entity) and can provide a connection to the financial entity via a different data API platform. These and other examples related to FIG. 1 are described in more detail below. In addition, FIG. 1 depicts, for illustrative purposes, a single user 104, any number of financial entities 108 (e.g., A, B, . . . . N), any number of third-party applications 110 (e.g., A, B, . . . . N), and any number of data API platforms 112 (e.g., A, B, . . . . N), and in examples, the disclosure may include any number of these elements (e.g., hundreds, thousands, millions, etc.).

The network(s) 102 may include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications may depend at least in part upon the type of network, the environment selected, or both. Protocols for communicating over such network(s) 102 are well known and are not discussed herein in detail.

In some examples, the user 104 may use services of one or more of the financial entities 108, such as banking (e.g., checking, savings, etc.), lending, brokerage, insurance, employee compensation and benefits management, credit, cryptocurrency, and the like. As such, and as a result of those services and activities/transactions of the user 104, information associated with the user 104 is generated and stored (e.g., as data or “the user's data”) by the financial entities 108. For example, the user's data may include various types of information, such as general account information, including account numbers, account ownership, account beneficiaries, account attributes (e.g., services provided by the financial entity in association with the account, interest rates, fees, max/min limitations, etc.), account permissions (e.g., who can access account information), owner identification details, passwords, authenticating details, verification details, and the like. In addition, the user's data may include transactions information, such as credits, debits, withdrawals, balances, fund transfers, recurring transactions, scheduled transactions, etc., as well as details associated with each transaction (e.g., amount, data, parties involved, transaction numbers, and the like). These are just some examples of the types of information that may be included in the user's data, which may include a variety of other types of information.

The user 104 can typically access the user's data in various manners. For example, if the user 104 requests services provided by the financial entity 108a, then the user 104 can often log in to an account via a web application or a mobile application provided by the financial entity 108a and, after proper authentication and verification, view the user's data and use services provided by the financial entity 108a (e.g., transfer money, pay bills, make purchases, etc.). The user 104 may similarly use services provided by the financial entities 108b and 108n, which may likewise result in additional user data associated with the user 104 and the respective services. Verification and authentication with each of the financial entities 108 may include various techniques, such as two-factor authentication (e.g., based on phone number, email, etc.), biometric authentication (e.g., fingerprint, facial recognition), and the like.

In some examples, the financial entities 108a, 108b, and 108n may provide a data API 109a, 109b, and 109n, which allows the user's data to be accessed. For example, a web/mobile application provided by a financial entity may use the financial entity's data API. In some examples, the user 104 may desire for one or more of the third-party applications 110 to access the user's data stored by the financial entities 108. For example, the third-party applications 110 may include one or more additional tools and/or services that supplement and/or increase services or tools available to the user 104 in association with their user data. In addition, the third-party applications 110 may provide another access point through which the user 104 can request services of the financial entities 108. Examples of third-party applications may include a mobile-payment application, a budgeting application, a trading application, and the like. Accordingly, in some instances, the third-party applications 110 may access the user's data via the data APIs 109a, 109b, and 109n.

The third-party applications 110 may operate in various manners. For example, a user 104 may download an instance or version of the third-party applications 110 to their user computing device 106 (e.g., desktop/laptop, tablet, mobile device, etc.). Although a client-side version of the third-party applications 110 is not depicted in FIG. 1, it is understood that the device 106 can include at least some portions of one or more of the third-party applications 110 that are operable to perform associated operations. In addition, as part of setting up a user profile or account associated with the user 104 (e.g., via the client-side version), the user 104 may verify their identity and provide one or more unique identifiers (e.g., phone number, social security number, email address, etc.). Furthermore, the user 104 may provide account details associated with one or more of the financial entities 108. Once the identity of the user 104 is verified, and proper approvals are received in association with the account(s) associated with the financial entities 108, the third-party applications 110 (e.g., including versions/instances on the device 106) may request the user's data associated with the financial entities 108, such as via the data APIs (e.g., 109a, 109b . . . 109n).

In some instances, one or more data API platforms 112 may provide services that assist with connecting to one or more of the data APIs 109a, 109b, and 109n and accessing data associated with a user. For example, data API platforms 112 may provide tools to securely and reliably connect to data APIs and compile data of the user 104 associated with one or more accounts. That is, when a connection is requested, such as by the user 104 and via one or more of the third-party applications 110, the third-party applications 110 may connect, by using one or more of the data API platforms 112, to the appropriate data API 109a, 109b, or 109n. In examples, the device 106 can be associated with (e.g., have downloaded) tools and functionalities associated with the data API platforms 112, which help with connection to, and retrieving information from, the financial entities 108 via the respective data APIs.

In some examples, the data API platforms 112 may operate differently from one another when accessing user data, which may also depend on the financial entity 108. For example, the data API platforms 112 may have relatively different connection durations/persistence, connection latency/delay, connection robustness, etc., depending on the data API platform 112 and on the financial entity 108. In one example, a data API platform (e.g., from 112) can maintain a different connection to one of the financial entities (e.g., 108a) as compared to a different one of the financial entities (e.g., 108b)—e.g., the connection persists longer, is faster, and/or is less likely to disconnect. In some examples, the data API platforms 112 may (as compared to one another) retrieve different user data, which may also depend on the financial entity 108. For example, the data API platform 112a may retrieve/compile from the financial entity 108a a first set of data associated with the user 104, whereas the data API platform 112b may retrieve/compile from the financial entity 108a a second set of data associated with the user 104 and different from the first set of data.

Conventionally, the third-party applications 110 may select from several different data API platforms 112 when requesting data associated with a user. For example, when one of the third-party applications 110 wants to request data associated with the user 104 from one of the financial entities 108, the third-party application may have the option to decide between using any of the data API platforms 112. Using conventional solutions, the third-party applications 110 may simply attempt to connect to a data API by using a first data API platform (e.g., a default data API platform, a last-used data API platform, a pre-selected data API platform, etc.) without any consideration as to whether conditions are met. Examples of conditions can include the connection to the financial entity (e.g., via the data API) being supported by the first data API platform, as well as historical performance associated with one or more connections (or connection attempts) to the financial entity via the first data API platform. As such, the third-party applications 110 may fail to account for likely connection failures and/or unsatisfactory performance, often resulting in delay (e.g., while waiting for a connection or a reconnection or issue resolution), inefficient computing (e.g., using more computing resources to attempt reconnection, switching to a new data API platform, attempting to resolve connection issues, etc.), or complete failure. In some instances, the first data API platform can, at one time, successfully connect (and support successful connection) to the financial institution, and at a subsequent time, not support connecting to the financial institution. For example, the first data API platform can unilaterally disconnect from, or no longer support connections to, the financial institution (e.g., to the data API of the financial institution).

Examples of the present disclosure, in contrast to conventional approaches, include a solution that can detect or predict or anticipate when a first data API platform might not provide a successful connection to the financial institution (e.g., to the data API of the financial institution) and can provide a connection via a different second data API platform. As such, the request to retrieve information from a financial entity via the third-party application can be successfully executed and the user can access their financial information via the third-party application. In examples, the different second API platform allows the user to access their information and options related to balances, withdrawal options, transfer options, investing options, and the like. In addition, the solutions associated with this disclosure can improve computing operations by reducing delays (e.g., that would otherwise be experienced while waiting for a connection or a reconnection or issue resolution) and improving computing efficiencies (e.g., using less computing resources to attempt reconnection, switching to a new data API platform, attempting to resolve connection issues, etc.). In some instances, the present invention, via the technical solutions described in this application, can prevent the user from being locked out from their account information (or delayed in accessing their account information). In addition, the present disclosure can increase the likelihood that the connection is reliable and fast enough and robust enough to service the user needs and requests via the application. The solutions herein can increase user accessibility to current financial resources and to tools that can be implemented to increase future financial resources.

In at least some examples, the present disclosure includes a data API connection changer 114 (also referred to as “connection changer 114”), at least a portion of which can operate on the device 106, on a separate computing device, or any combination thereof. In some examples, the connection changer 114 may include components (e.g., one or more processors, computer-readable media, one or more communication interfaces, and input/output devices) that are configured to implement any number of functional components. In many implementations, these functional components comprise instructions or programs that are executable by the processor(s) and that, when executed, specifically configure the processor(s) to perform actions attributed in this disclosure to server(s) or other computing devices. Functional components stored in the computer-readable media may include a financial entity identifier 116, a connection failure predictor 118, a connection authorizer 120, and a data API platform connector 122, each of which can include one or more additional components.

In at least some examples, at least a portion of the data API connection changer 114 can include a software development kit (SDK). In at least some examples, at least a portion of the data API connection changer 114 can sit on top of a SDK (e.g., on the device 106) associated with one or more of the third-party applications 110 and/or one or more of the data API platforms 112.

In at least some examples, the financial entity identifier 116 is configured to determine, in association with the user 104 using one of the third-party applications (e.g., the third-party application 110a), from which financial entity the user 104 is requesting information. In addition, the connection failure predictor 118 can be configured to predict, detect, or anticipate when a first data API platform (e.g., a data API platform set as a default by the third-party application; last-used by the third-party application; etc.) is not likely to provide a successful connection to the financial entity (e.g., the first data API platform does not support connecting to the financial entity or is likely to fail to connect to the financial entity or is likely to provide a low-quality connection to the financial entity). In some examples, the connection authorizer 120 can request permission from the user 104 to use a different second data API platform, which is not likely to experience a connection failure. In at least some instances, the data API platform connector 122 can send the request to the different data API platform that has been authorized. These and other components are described further below.

In at least some examples, the financial entity identifier 116 can include an event receiver 124 that receives one or more events associated with the third-party application (e.g., 110a) and/or a first data API platform (e.g., 112a). In examples, the event receiver 124 can receive any event that can indicate whether a connection to a financial entity is likely to fail to meet threshold connection requirements (e.g., speed, low latency, duration, etc.) and/or to fail to connect at all. For example, the event receiver 124 can receive an event that indicates an input (e.g., by the user 104) of at least a portion of a unique identifier (e.g., name, number, character, etc.) associated with a financial entity (e.g., 108a). In some examples, the portion of the unique identifier can indicate a single character, such as a letter or number. In some examples, the portion can include two or more characters. In some examples, at least a portion of the unique identifier can include all characters associated with a full portion of a name/identifier of a financial entity. Stated differently, as a user 104 inputs the name of a financial entity (e.g., into an input field associated with a third party app 110), the event receiver can receive one or more of the characters that are input (e.g., by receiving one or more characters in sequence).

In at least some examples, the event received by the event receiver 124 can indicate the first data API platform (e.g., 112a) that the third-party application (e.g., 110a) might try to use to connect to the financial entity (e.g., 108a) that is identified. Also, in some instances, an indication of the first data API platform (e.g., 112a) can be provided (e.g., to the data API connection changer 114) by some other source (e.g., prior to or after receiving the event indicating the financial entity).

In at least some examples, the event received by the event receiver 124 can indicate information about a prior attempt by the first data API platform (e.g., 112a) to connect to the financial entity (e.g., 108a). For example, the information received by the event receiver 124 (e.g., from the third-party application 110a and/or the first data API platform 112a) can indicate that a prior attempt to connect failed, timed out, was too slow (e.g., below a threshold), etc. Stated differently, the third-party app 110 and/or the data API platform 112 can communicate events to the event receiver 124 that include information related to connections. The data API connection changer 114 can then use that information to assess whether the connections met threshold connection metrics and/or failed entirely.

In at least some examples, the connection failure predictor 118 can receive information from the event receiver 124 (or from the financial entity identifier 116) and use that information to determine that a connection to the financial entity (e.g., 108a) via the first data API platform (e.g., 112a) is not supported, has failed, is likely to fail, or is likely to be associated with connection issues (e.g., to slow, intermittent, etc.). In at least some examples, the connection failure predictor 118 can reference a keywords list 126, including a list of financial entities (e.g., a list of complete names or other identifiers associated with financial entities, as well as partial names or other identifiers associated with financial entities). Also, the keywords list 126 can include a list of data API platforms. In addition, the keywords list 126 can include an indication of whether a connection to a financial entity (e.g., the data API of the financial entity) by a data API platform (e.g., the first data API platform 112a) is not supported and/or has failed in a prior connection attempt to connect or to meet threshold connection performance requirements. The keywords list 126 can be, in some examples, pre-populated in (or otherwise stored in connection with) the connection failure predictor 118. The keywords list 126, including the indication of whether a connection is not supported or is likely to fail or meet performance metrics, can be based on various factors, such as known instances or reporting of a data API platform not supporting connection to financial entity (e.g., the data API of the financial entity), tracked connection performance (e.g., connection duration, time to connect, etc.), or a combination thereof. Stated differently, in some example, the data API connection changer 114 can maintain the keywords list 126, which can include a list of any financial entities for which a connection experienced any connection performance issues (e.g., too slow, too delayed, not persistent, failed entirely, no longer supported by one or more data API platforms 112). In addition, financial institution names (or portions of financial institution names) can be added to (or removed from) the keywords list 126 for any reason at all. The keywords list 126 can be maintained by an entity associated with the changer 114. The keywords list 126 can be updated, in some examples, at the request of the financial entity (e.g., where the financial entity wants their name added to the list or removed from the list). In some examples, the keywords list 126 can be populated, or updated, by a download or update that is pushed to the mobile device 106 (e.g., where the download or update is provided by a third-party application, by an entity associated with the changer 114, by a data API platform, by a financial institution, or any combination thereof). In some examples, the keywords list 126 can be populated or updated by software executed on a device (e.g., user device 106), such as where a connection to a financial entity fails to meet performance parameters (e.g., the event receiver 124 receives an event indicating as such), and as such, the financial entity name (or identifying characters associated with the financial entity) are automatically added to the keywords list (e.g., without necessarily requiring a download or update).

In at least some examples, the keywords list 126 can include a list of financial entities (e.g., a list of complete names or other identifiers associated with financial entities, as well as partial names or other identifiers associated with financial entities) for which a known connection failure (or other connection performance issues) exists in association with a first data API platform (e.g., 112a). That is, including of a financial entity (or a keyword, phrase, or character(s) associated with the financial entity) on the list 126 (e.g., complete or partial name) can indicate that the first data API platform (e.g., 112a) does not support connection to that financial entity or is likely to fail to connect or to provide a connection that fails to meet performance requirements (e.g., persistence, speed, etc.).

In at least one example, the connection failure predictor 118 can compare the information received by the event receiver 124 (e.g. one or more characters associated with a financial entity) to the keywords list 126, such as by performing a look-up operation. In addition, based on the results of the look-up operation, the connection failure predictor 118 can determine whether a connection to the financial entity (e.g., 108a) via the first data API platform (e.g., 112a) fails to meet one or more conditions. Examples of conditions can include the connection to the financial entity (e.g., 108a) being supported by the first data API platform (e.g., 112a) and/or successful prior connection attempt to the financial entity (e.g., 108a) via the first data API platform (e.g., 112a). A prior connection attempt can, in some examples, be deemed unsuccessful (e.g., the condition is not met) if the prior connection attempt failed (e.g., the connection was not made), if the prior connection attempt took too long, or if the prior connection attempt failed to satisfy connection performance metrics (e.g., connection to slow, not persistent, etc.).

In some examples, an interaction between the event receiver 124 and the connection failure predictor 118 is iterative. For example, the event receiver 124 can receive a first event that includes one or more characters representing an initial portion of an identifier or name associated with a financial entity 108. The connection failure predictor 118 can receive the one or more characters and compare the one or more characters to the keywords list 126. If a positive match is found, the connection failure predictor 118 can proceed accordingly based on a determination as to whether a connection is not supported, is likely to fail, or is likely to be associated with connection issues (e.g., to slow, intermittent, etc.). In some instances, the comparison by the connection failure predictor 118 might be inconclusive (e.g., no positive match is returned or multiple financial entities are identified). As such, the event receiver 124 can receive a subsequent event, such as where the user continues to input one or more additional characters. In examples, the one or more additional characters can be communicated to the connection failure predictor 118 to update the search, comparison, or lookup associated with the keywords list 126. The process can continue until a determination is made regarding whether a connection is not supported, is likely to fail, or is likely to be associated with connection issues (e.g., to slow, intermittent, etc.). In some examples, the iterative process can occur prior to communicating with the connection failure predictor to first identify a financial entity and then reference the keywords list 126 via the connection failure predictor 118.

In at least some examples, the connection authorizer 120 can, based on the determination that a connection is not supported, has failed, is likely to fail, or is likely to be associated with connection issues, receive authorization from the user 104 to connect to the financial entity (e.g., 108a) via a second data API platform (e.g., 112b). For example, the connection authorizer 120 can present (e.g., via a graphical user interface) information associated with the second data API platform (e.g., 112b), as well as a request authorization details associated with the user and the financial entity (e.g., user name, password, etc.).

Based on the authorization to use the second data API platform (e.g., 112b), the data API platform connector 122 can establish the connection via the second data API platform (e.g., 112b) to request and receive information from the financial entity (e.g., 108a), such as to be used in association with the third-party applications 110.

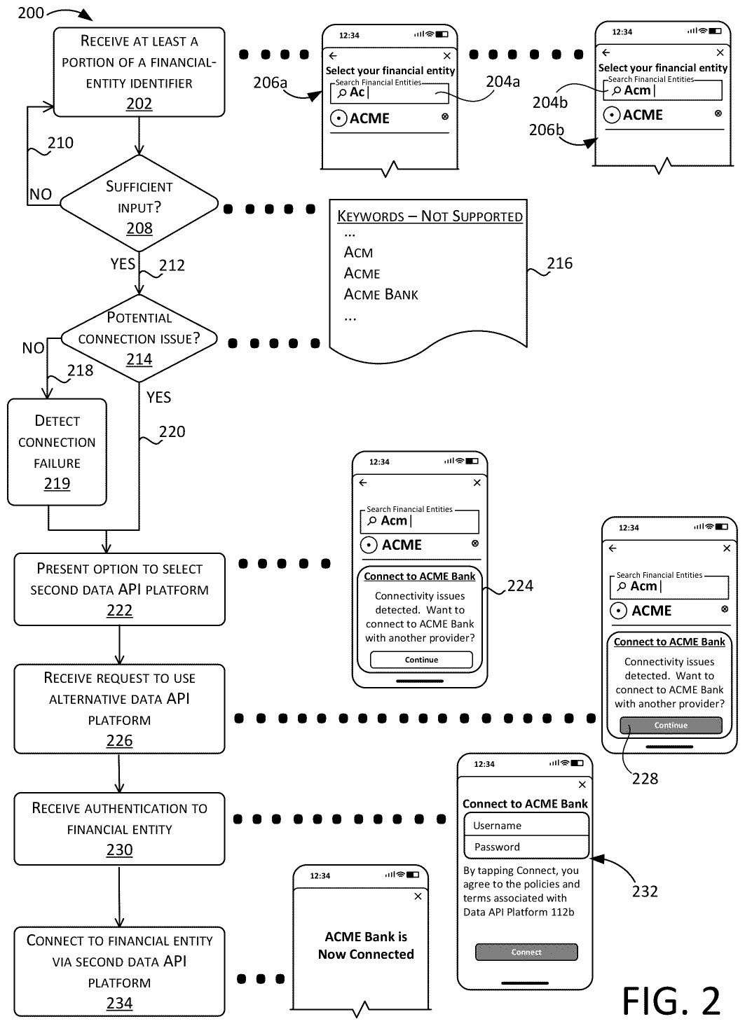

Referring now to FIG. 2, additional details associated with the present disclosure are described, including a method 200. Each block of method 200 can include a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), a plug-in to another product, a software developer kit, to name a few. In addition, method 200 is described, by way of example, with respect to the system of FIG. 1. However, this method 200 may additionally or alternatively be executed by any one system, or any combination of systems, including, but not limited to, those described herein. In addition, any one or more blocks of the method 200 can be omitted and/or reordered in examples of the present disclosure, and consistent with any claimed subject matter.

The method 200 can include detecting that a connection to a financial entity 108a via a first data API platform 112a fails to meet one or more conditions and providing an option to connect to the financial entity 108b via a second data API platform 112b. Examples of conditions can include the connection to the financial entity 108a being supported by the first data API platform 112a; the connection to the financial entity 108a via the first data API platform 112a not previously failing; the connection to the financial entity 108a via the first data API platform 112a not previously including low performance metrics; the connection to the financial entity 108a via the first data API platform not being predicted to fail or to include low performance metrics; or any and all combinations thereof.

FIG. 2 includes, based on some examples, pictorials (e.g., GUIs, lists, etc.) to illustrate at least some aspects of operations of the method 200, however, the operations are not limited to what is depicted in those pictorials. The GUIs could in some examples be presented via the user device 106 in association with the method 200 and the operations associated therewith. In at least one example, the GUIs in FIG. 2 can include elements that are associated with one or more third-party applications 110, one or more data API platforms 112, the data API platform changer 114, or any and all combinations thereof.

The method 200 includes, at 202, receiving (e.g., by the event receiver 124) at least a portion of an identifier associated with a financial entity (e.g., data or first data comprising or representing at least a portion of the identifier). For example, one or more characters can be input into a text box 204a, which is associated with a first GUI 206a at a first time instant. In some examples, the text box 204a is a GUI element that is part of the third-party application 110a and/or the data API platform 112a (e.g., the first data API platform 112a). In at least some examples, an event can be passed to the event receiver (e.g., passed by the third-party application 100a or the first data API platform 112a), the event including the at least the portion of the identifier that was input into the text box 204a.

At operation 208, the method can proceed alternatively depending on the information received in operation 202 (e.g., depending on the characters received). For example, if the characters received as part of operation 202 are insufficient to identify a financial entity 108 and/or to determine whether a connection is not supported or likely to fail or likely to have connectivity issues, then the operations can repeat via branch 210. In that case, the operations can include receiving (e.g., by the event receiver 124) one or more additional characters that are input into the text box 204b, which is the text box 204a at a subsequent time instant. On the other hand, if the input received in operations 202 is sufficient to identify a financial entity, then the process can proceed via branch 212.

This iterative process is illustrated by the GUIs 206a and 206b. For example, the input provided in the text box 204a of the GUI 206a includes “Ac,” which might be insufficient to identify a single financial entity and/or to determine whether a connection is not supported or likely to fail or likely to have connectivity issues. For instance, a first financial entity can include “ACME Bank” whereas a second financial entity could include “ACE Investments,” such that the input “Ac” is insufficient to distinguish between the first and second financial entities. As such, the process 202 can repeat (via branch 210), including receiving the input “Acm” that is input into the text box 204b associated with GUI 206b. In at least one example, a sufficiency of the input (at step 208) is based on whether a match is identified in the keyword list 126 (e.g., another example keyword list 216 is depicted in FIG. 2) or some other keyword list associated with the financial entity identifier 116 and/or the connection failure predictor 118.

In some examples, the method can include, at operation 214, determining whether any issues are associated with a connection to a data API 109a of the financial entity 108a via the first data API provider 112a (e.g., the connection is not supported by the first data API provider 1112a, has previously failed or connected with poor performance, is likely to fail, is likely to experience low-quality connection issues, or any combinations thereof). For example, the connection failure predictor 118 can compare information included in the event to one or more keyword lists (e.g., “Flagged Keywords” 216). In some examples, an issue can be determined where the character string is included on the keywords list. In some examples, an issue can be determined where the character string is omitted from the keywords list.

If a determination is not made, at step 214 (e.g., based on the keywords list), that the connection via the data API platform 112a is not supported, has previously failed or connected with poor performance, is likely to fail, or is likely to experience low-quality connection issues, then the method 200 can proceed along branch 218 (e.g., “NO” branch), which is explained in further detail below.

If a determination is made, at step 214 (e.g., based on the keywords list), that the connection via the data API platform 112a is not supported, has previously failed or connected with poor performance, is likely to fail, or is likely to experience low-quality connection issues, then the method 200 can proceed along branch 220 (e.g., “YES” branch).

In at least some examples, at operation 222, an option can be presented to connect to the financial entity 108a (e.g., Acme Bank) via a second data API platform 112b. For example, a sheet 224 (or other GUI element) can be presented (e.g., by the connection authorizer 120), which indicates that the first data API platform 112a does not support connecting to the financial entity 108a and providing an option to submit a request to connect via a second data API platform 112b (e.g., “Continue” button on sheet 224).

In addition, at operation 226, the method 200 can include receiving a request to connect to the financial entity 108a (e.g., Acme Bank) via the second data API platform 112b, such as via the user 104 selecting the Continue button 228 (e.g., as illustrated by the difference in color associated with the Continue button 228).

In examples, in step 230, based on the request to connect to the financial entity 108a (e.g., Acme Bank) via the second data API platform 112b, authorization to connect to the financial entity 108a can be requested and received. For example, an authentication GUI 232 can be presented by the connection authorizer 120.

In at least some examples, in step 234, based on the authorization, the data API platform connector 122 can connect to the financial entity 108a via the second data API platform 112a, such that the connection has changed from the first data API platform 112a to the second data API platform 112b.

As indicated above, in some instances, the identification of a financial entity may not (e.g., by itself) trigger branch 220 and the ensuing operations, such that operations proceed based on the branch 218. In some examples the method 200 can include, at operation 219, detecting a failure associated with an attempt to connect to the financial entity 108a via the first data API provider 112a. For instance, the third-party application can attempt to connect to the financial entity 108a via the first data API provider 112a, and the attempt might fail altogether or be associated with one or more other performance metrics indicating a low-quality connection. As such, even though a potential issue may not have been initially flagged and the connection attempt was made via the first data API platform, the data API platform can still be updated/changed where the attempt fails to meet threshold requirements or fails altogether.

In at least some examples, the event receiver 124 can receive an event indicating the failed connection or the low-quality connection, which can trigger the connection authorizer 120 to present an option to connect via the second data API provider.

Examples of the present disclosure may include one or more processors, one or more computer readable media, one or more communication interfaces, and one or more I/O devices. In at least one example, a processor may include a single processing unit or multiple processing units and may include single or multiple computing units or multiple processing cores. The processor(s) may be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) may be one or more hardware processors and/or logic circuits of any suitable type specifically programmed or configured to execute the algorithms and processes described herein. The processor(s) may be configured to fetch and execute computer-readable instructions stored in the computer-readable media, which may program the processor(s) to perform the functions described herein.

Computer-readable media may include volatile and nonvolatile memory and/or removable and non-removable media implemented in any type of technology for storage of data, such as computer-readable instructions, data structures, program modules, or other data. Such computer-readable media may include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that may be used to store the desired data and that may be accessed by a computing device. Depending on the configuration of the server(s), the computer-readable media may be a type of computer-readable storage media and/or may be a tangible non-transitory media to the extent that when mentioned, non-transitory computer-readable media exclude media such as energy, carrier signals, electromagnetic waves, and signals per se.

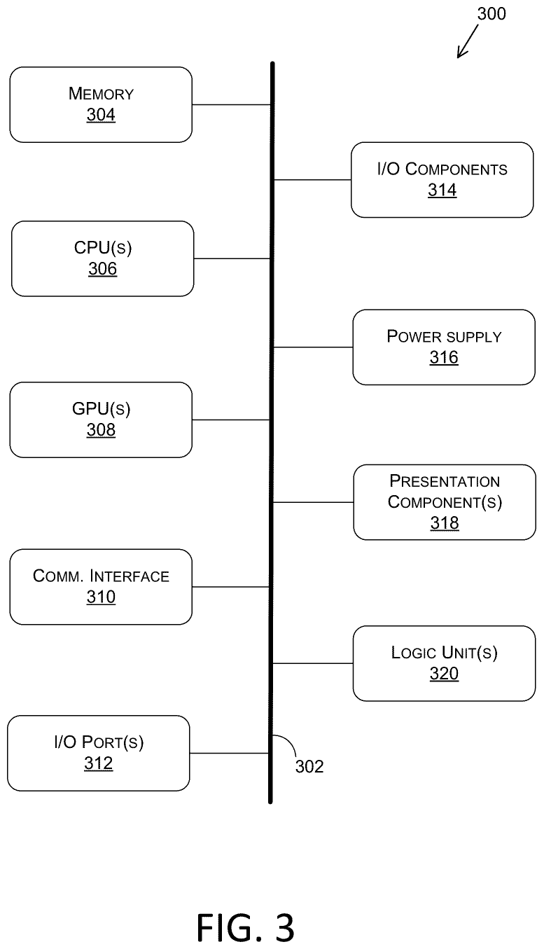

Referring to FIG. 3, FIG. 3 is a block diagram of an example computing device(s) 300 suitable for use in implementing some examples of the present disclosure. Computing device 300 may include an interconnect system 302 that directly or indirectly couples the following devices: memory 304, one or more central processing units (CPUs) 306, one or more graphics processing units (GPUs) 308, a communication interface 310, input/output (I/O) ports 312, input/output components 314, a power supply 316, one or more presentation components 318 (e.g., display(s)), and one or more logic units 320. In at least one embodiment, the computing device(s) 300 may comprise one or more virtual machines (VMs), and/or any of the components thereof may comprise virtual components (e.g., virtual hardware components). For non-limiting examples, one or more of the GPUs 308 may comprise one or more vGPUs, one or more of the CPUs 306 may comprise one or more vCPUs, and/or one or more of the logic units 320 may comprise one or more virtual logic units. As such, a computing device(s) 300 may include discrete components (e.g., a full GPU dedicated to the computing device 300), virtual components (e.g., a portion of a GPU dedicated to the computing device 300), or a combination thereof.

Although the various blocks of FIG. 3 are shown as connected via the interconnect system 302 with lines, this is not intended to be limiting and is for clarity only. For example, in some embodiments, a presentation component 318, such as a display device, may be considered an I/O component 314 (e.g., if the display is a touch screen). As another example, the CPUs 306 and/or GPUs 308 may include memory (e.g., the memory 304 may be representative of a storage device in addition to the memory of the GPUs 308, the CPUs 306, and/or other components). In other words, the computing device of FIG. 3 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 3.

The interconnect system 302 may represent one or more links or busses, such as an address bus, a data bus, a control bus, or a combination thereof. The interconnect system 302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 306 may be directly connected to the memory 304. Further, the CPU 306 may be directly connected to the GPU 308. Where there is direct, or point-to-point connection between components, the interconnect system 302 may include a PCIe link to carry out the connection. In these examples, a PCI bus need not be included in the computing device 300.

The memory 304 may include any of a variety of computer-readable media. The computer-readable media may be any available media that may be accessed by the computing device 300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 306 may be configured to execute at least some of the computer-readable instructions to control one or more components of the computing device 300 to perform one or more of the methods and/or processes described herein. The CPU(s) 306 may each include one or more cores (e.g., one, two, four, eight, twenty-eight, seventy-two, etc.) that are capable of handling a multitude of software threads simultaneously. The CPU(s) 306 may include any type of processor, and may include different types of processors depending on the type of computing device 300 implemented (e.g., processors with fewer cores for mobile devices and processors with more cores for servers). For example, depending on the type of computing device 300, the processor may be an Advanced RISC Machines (ARM) processor implemented using Reduced Instruction Set Computing (RISC) or an x86 processor implemented using Complex Instruction Set Computing (CISC). The computing device 300 may include one or more CPUs 306 in addition to one or more microprocessors or supplementary co-processors, such as math co-processors.

In addition to or alternatively from the CPU(s) 306, the GPU(s) 308 may be configured to execute at least some of the computer-readable instructions to control one or more components of the computing device 300 to perform one or more of the methods and/or processes described herein. One or more of the GPU(s) 308 may be an integrated GPU (e.g., with one or more of the CPU(s) 306 and/or one or more of the GPU(s) 308 may be a discrete GPU. In embodiments, one or more of the GPU(s) 308 may be a coprocessor of one or more of the CPU(s) 306. The GPU(s) 308 may be used by the computing device 300 to render graphics (e.g., 3D graphics) or perform general purpose computations. For example, the GPU(s) 308 may be used for General-Purpose computing on GPUs (GPGPU).

In addition to or alternatively from the CPU(s) 306 and/or the GPU(s) 308, the logic unit(s) 320 may be configured to execute at least some of the computer-readable instructions to control one or more components of the computing device 300 to perform one or more of the methods and/or processes described herein. In embodiments, the CPU(s) 306, the GPU(s) 308, and/or the logic unit(s) 320 may discretely or jointly perform any combination of the methods, processes and/or portions thereof. One or more of the logic units 320 may be part of and/or integrated in one or more of the CPU(s) 306 and/or the GPU(s) 308 and/or one or more of the logic units 320 may be discrete components or otherwise external to the CPU(s) 306 and/or the GPU(s) 308. In embodiments, one or more of the logic units 320 may be a coprocessor of one or more of the CPU(s) 306 and/or one or more of the GPU(s) 308.

Examples of the logic unit(s) 320 include one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 310 may include one or more receivers, transmitters, and/or transceivers that enable the computing device 300 to communicate with other computing devices via an electronic communication network, included wired and/or wireless communications. The communication interface 310 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The I/O ports 312 may enable the computing device 300 to be logically coupled to other devices including the I/O components 314, the presentation component(s) 318, and/or other components, some of which may be built in to (e.g., integrated in) the computing device 300. Illustrative I/O components 314 include a microphone, mouse, keyboard, joystick, game pad, game controller, satellite dish, scanner, printer, wireless device, etc. The I/O components 314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 300. The computing device 300 may be include depth cameras, such as stereoscopic camera systems, infrared camera systems, RGB camera systems, touchscreen technology, and combinations of these, for gesture detection and recognition. Additionally, the computing device 300 may include accelerometers or gyroscopes (e.g., as part of an inertia measurement unit (IMU)) that enable detection of motion. In some examples, the output of the accelerometers or gyroscopes may be used by the computing device 300 to render immersive augmented reality or virtual reality.

The power supply 316 may include a hard-wired power supply, a battery power supply, or a combination thereof. The power supply 316 may provide power to the computing device 300 to enable the components of the computing device 300 to operate.

The presentation component(s) 318 may include a display (e.g., a monitor, a touch screen, a television screen, a heads-up-display (HUD), other display types, or a combination thereof), speakers, and/or other presentation components. The presentation component(s) 318 may receive data from other components (e.g., the GPU(s) 308, the CPU(s) 306, etc.), and output the data (e.g., as an image, video, sound, etc.).

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving first data comprising one or more characters identifying a financial entity, which is associated with a data application programming interface (API);
presenting, based on a comparison of the first data to a list, an option to connect to the data API via a data API platform;
receiving authorization to connect to the data API via the data API platform; and
connecting to the data API via the data API platform.

2. The method of claim 1, wherein the list comprises second data comprising the one or more characters identifying the financial entity.

3. The method of claim 1, wherein the list comprises the second data based on a connection to the data API via a second data API platform failing to meet one or more conditions.

4. The method of claim 3, wherein the one or more conditions comprise successfully connecting to the data API via the second data API platform in a prior connection attempt.

5. The method of claim 3, wherein the one or more conditions comprise a connection to the data API via the second data API platform including a connection performance metric satisfying a threshold.

6. The method of claim 5, wherein the connection performance metric comprise one or more of connection speed, connection persistence, or connection latency.

7. The method of claim 3, wherein the one or more conditions comprise the second data API platform supporting a connection to the data API.

8. The method of claim 1, wherein the list comprises a portion of a first software developer kit (SDK) for connecting to the data API via the data API platform.

9. The method of claim 8, wherein the first SDK is organized on top of a second SDK for connecting to the data API via a second data API platform, which is different from the first data API platform.

10. A method comprising:
receiving first data comprising information associated with connecting, via a first data API platform, to a data API of a financial entity;
determining that connecting, via the first data API platform to the data API, fails to meet one or more conditions;
receiving authorization to connect to the data API via a second data API platform; and
connecting to the data API via the second data API platform.

11. The method of claim 10, wherein the one or more conditions comprises the first data API platform supporting a connection to the data API.

12. The method of claim 11, wherein:
the first data comprises one or more characters identifying the financial entity; and
the determining comprises comparing the first data to a list.

13. The method of claim 10, wherein the one or more conditions comprises successfully connecting to the data API via the first data API platform in a prior connection attempt.

14. The method of claim 8, wherein the one or more conditions comprises a connection to the data API via the first data API platform including a connection performance metric satisfying a threshold.

15. The method of claim 14, wherein the connection performance metric comprises one or more of connection speed, connection persistence, or connection latency.

16. The method of claim 10, wherein the first data is received by a portion of a first software developer kit (SDK) for connecting to the data API via the second data API platform.

17. The method of claim 16, wherein the first SDK receives the first from a second SDK for connecting to the data API via the first data API platform.

18. The method of claim 10, wherein failure to meet the one or more conditions would delay connecting to the data API, prevent connecting to the data API, result in a connection that fails to satisfy one or more connection performance metrics, or any combination thereof.

19. The method of claim 18, wherein the failure to meet the one or more conditions would delay access, via a mobile application, to financial information; prevent access, via the mobile application, to financial information; or any combination thereof.

20. The method of claim 18, wherein connecting to the data API via the second data API platform provides, as compared to the first data API platform, faster access, via the mobile application, to the financial information.
